(19) United States
(12) Patent Application Publication
(10) Pub. No.: US 2010/0128373 A1
(43) Pub. Date: May 27, 2010

(54) SELF-ALIGNING SPOTTER MIRROR

(76) Inventor: Michael A. Sandberg, Milwaukee, WI (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/323,711

(22) Filed: Nov. 26, 2008

(51) Int. Cl. G02B 5/08

(52) U.S. Cl. 359/850

(57) ABSTRACT

A spotter mirror mountable to a reflector has a back, a front reflecting surface, and a locator. The locator facilitates locating the spotter mirror at a predetermined location on the reflector such that the back of the spotter mirror abuts the reflector.

### TECHNICAL FIELD

The mirror described herein relates generally to the field of compound mirrors.

### BACKGROUND

As the number and speed of vehicles on the road increase, rearward and lateral visibility became ever more important. To assist in rearward and lateral visibility, motor vehicles, such as cars and trucks, have mirrors so that the driver can view the areas around and behind the vehicle that are otherwise difficult for the driver to observe. These mirrors are often mounted both inside and outside of the vehicle.

Frequently, the left outside mirror is typically flat (i.e., planar) providing a relatively true representation of the distance between the driver's vehicle and vehicles disposed behind the driver's vehicle. The right or passenger outside mirror of a passenger vehicle is often convex providing a magnified view such that the distance between the driver's vehicle and vehicles disposed behind the driver's vehicle appears to be greater than is really the case. Typically the radius of curvature of the passenger outside mirror is large, providing only enough enlargement of the field of view so as to compensate for the greater distance between the mirror and the driver's eye. Significant blind spots still exist on the passenger side mirror in most of today's vehicles.

Unfortunately, neither outside mirror provides adequate visibility to view cars that are disposed in the adjacent right or left-hand lane and that are close, such as within one car length, to the rear of the driver's vehicle. Thus, a blind spot exists where a vehicle in the blind spot of the driver's vehicle is not visible in either the inside mirror or the left outside mirror.

A common method of working around the blind spot is to add a spherically convex spotter mirror to the right or left outside mirror. Spherically convex mirrors provide a wider field of view than the typical flat or planar mirror. A spotter mirror if frequently a stick-on convex mirror that is adhesively mounted directly on the reflective surface of the planar mirror. Such a spotter mirror is shown in U.S. Published Application No. 2003/0117731.

Known spotter mirrors have a flat back. The flat back carries an adhesive that is used to adhesively bond the spotter mirror onto the planar left outside mirror. Unfortunately, the flat back of the spotter mirror makes it difficult to consistently and accurately place the spotter mirror at the desired location on the outside mirror. In addition, these spotter mirrors are often placed on areas of the mirrors' glass that are critical to an unobstructed view of objects in the mirrors' blind spots. Normally, a mirror's upper outside corner is the optimal location for the spotter mirror because this area typically reflects the sky or horizon where other vehicles or objects are not located. Unfortunately, the design of current spotter mirrors allows them to be placed anywhere in the viewing area with the result that visibility is often impaired. Moreover, if the installer misplaces the spotter mirror on the mirror glass, the aggressive nature of the adhesive that is typically used to attach the spotter mirror to the mirror glass makes it very difficult to relocate the spotter mirror on the mirror glass without damaging the spotter mirror.

The spotter mirror described therein overcomes one or more of these or other problems.

### BRIEF DESCRIPTION OF THE DRAWINGS

The spotter mirror described herein will be more fully understood from the below detailed description when taken in conjunction with the drawings in which:

FIG. 1 illustrates a left outside mirror that is typically used on a vehicle;

FIG. 2 illustrates only the reflector of the left outside mirror of FIG. 1;

FIG. 3 is one perspective view of a spotter mirror that can be assembled to the reflector of the left outside mirror of FIG. 1;

FIG. 4 is another perspective view of the spotter mirror that can be assembled to the reflector of the left outside mirror of FIG. 1;

FIG. 5 is a right side view of the spotter mirror that can be assembled to the reflector of the left outside mirror of FIG. 1;

FIG. 6 is one perspective view the spotter mirror assembled to the reflector of the left outside mirror of FIG. 1;

FIG. 7 is another perspective view the spotter mirror assembled to the reflector of the left outside mirror of FIG. 1;

FIG. 8 illustrates the assembly of the left outside mirror of FIG. 1 with the spotter mirror; and,

FIG. 9 compares the fields of view as specified by standard, as implemented by a typical OEM mirror, and as provided by the OEM mirror equipped with a spotter mirror.

### DETAILED DESCRIPTION

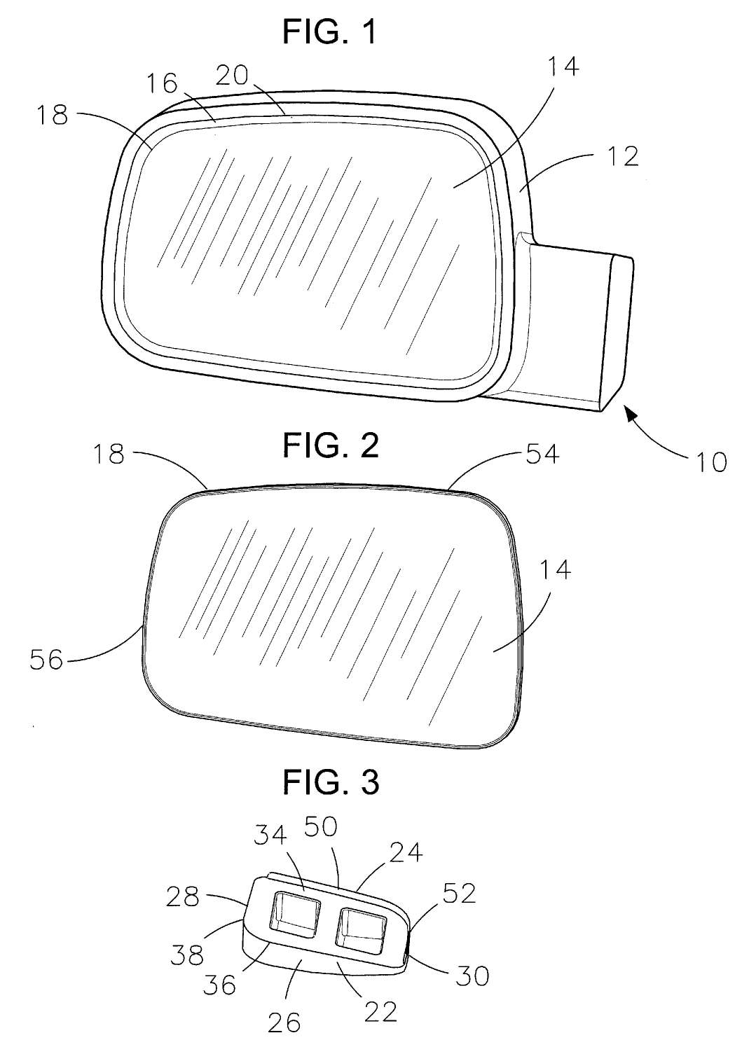

A left outside mirror 10 is shown in FIG. 1 and includes a mirror housing 12 to which a reflector 14 is suitably mounted. Normally, there is a space 16 between a perimeter 18 of the reflector 14 and an inside perimeter of an edge 20 of the mirror housing 12 that surrounds the perimeter 18 of the reflector 14. The space 16 is frequently used to accommodate movement of the reflector 14 within the mirror housing 12 usually under remote control of the driver. The reflector 14 is shown in FIG. 2 removed from the mirror housing 12. The reflector 14 may be mirror glass or other forms of reflective material.

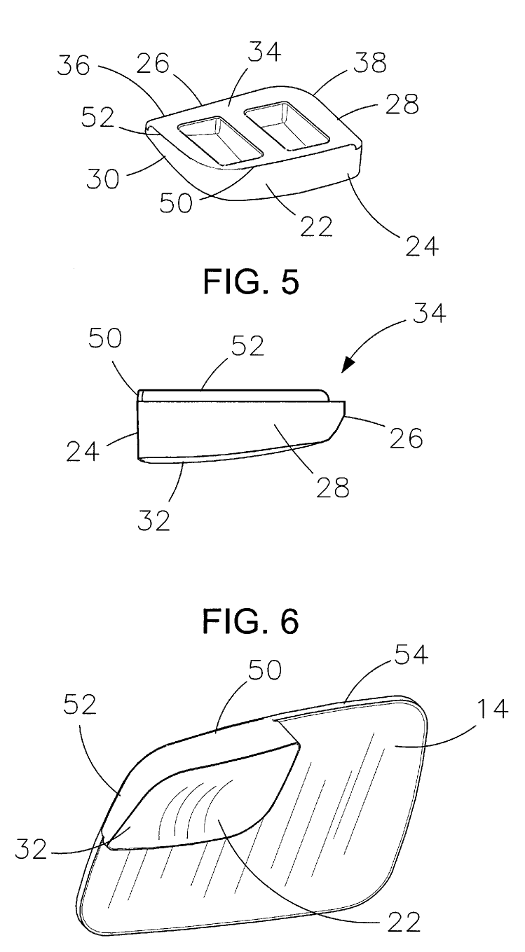

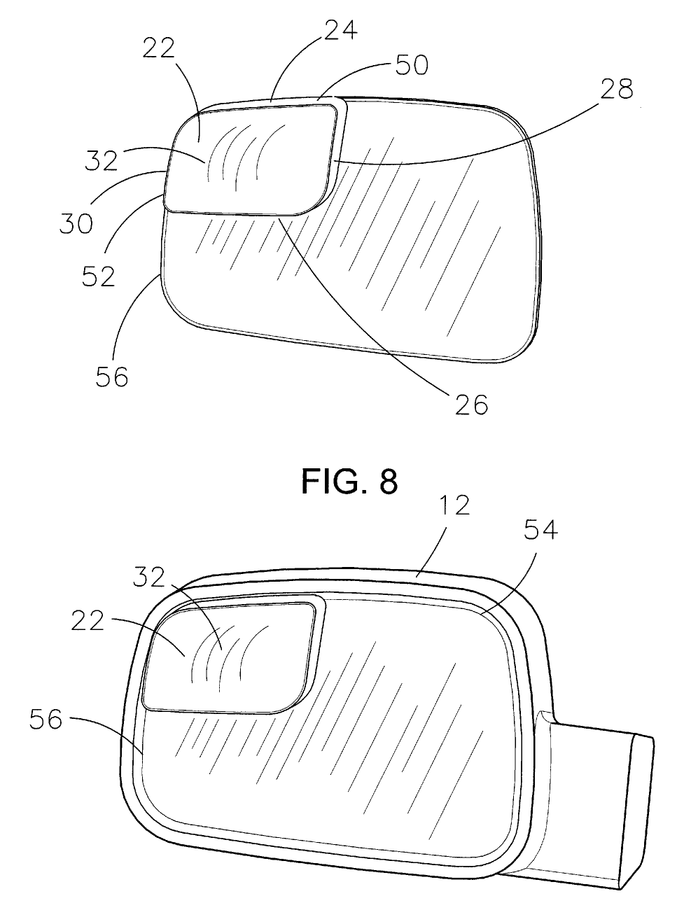

A spotter mirror 22 is shown in FIGS. 3, 4, and 5. The spotter mirror 22 has a top 24, a bottom 26, a right side 28, and a left side 30. The spotter mirror 22 also has a convex reflective front 32 (FIGS. 6-8) and a stick-on back 34 (FIGS. 3 and 4). The stick-on back 34, for example, comprises adhesive covered with a paper backing that can be removed at the time of installation to expose the adhesive that is used to bond the spotter mirror 22 to the reflector 14 as shown in FIGS. 6-8.

As shown in FIGS. 3 and 4, a back edge 36 of the bottom 26 and a back edge 38 of the right side 28 should preferably not extend backwards beyond the stick-on back 34 of the spotter mirror 22. This relationship allows the back 34 of the spotter mirror 22 to be mounted flush against the plane of the reflector 14 as shown in FIGS. 6-8.

However, as shown in FIGS. 3, 4, and 5, an extended edge 50 of the top 24 and an extended edge 52 of the left side 30 extend above the plane of the stick-on back 34 of the spotter mirror 22. The extended edge 50 of the top 24 and the extended edge 52 of the left side 30 act as locators to permit an installer to accurately position the spotter mirror 22 on the reflector 14 when the spotter mirror 22 is adhesively bonded to the reflector 14 during installation of the spotter mirror 22.

Accordingly, during installation of the spotter mirror 22 onto the reflector 14, the adhesive on the back 34 of the spotter mirror 22 is exposed and the back 34 of the spotter mirror 22 is applied to the reflector 14.

As the back 34 of the spotter mirror 22 is being applied to the reflector 14, the spotter mirror 22 is applied to the reflector 14 so that the extended edge 50 of the top 24 of the spotter mirror 22 wraps a top or perimeter edge 54 of the reflector 14. Thus, an inner surface of the extended edge 50 of the top 24 of the spotter mirror 22 overlaps and rests on the top edge 54 of the reflector 14.

Similarly, as the back 34 of the spotter mirror 22 is being applied to the reflector 14, the spotter mirror 22 is applied to the reflector 14 so that the extended edge 52 of the left side 30 of the spotter mirror 22 wraps a left side or perimeter edge 56 of the reflector 14. Thus, an inner surface of the extended edge 52 of the left side 30 of the spotter mirror 22 overlaps and rests on the left edge 56 of the reflector 14.

The space 16 between the perimeter 18 of the reflector 14 and the inside perimeter of the edge 20 of the mirror housing 12 that surrounds the perimeter 18 of the reflector 14 is sufficient to accommodate the extended edges 50 and 52 of the spotter mirror 22 as the extended edges 50 and 52 extend into the space 16.

In the manner described above, the extended edges 50 and 52 of the spotter mirror 22 are locators that, as shown in FIGS. 6-8, allow the spotter mirror 22 to be consistently and accurately positioned at the upper left hand corner of the reflector 14 during installation of the spotter mirror 22 on the left outside mirror 10.

The spotter mirror 22 is thus an auxiliary convex mirror that increases the field of view to the side and back of the vehicle to which it is mounted. The overall shape and size of the spotter mirror 22 is designed to allow the left outside mirror 10 to meet the Federal Motor Vehicle Safety Standard 111 for minimum surface area and field of view. The left outside mirror 10 with the spotter mirror 22 can be made to meet this standard. However, the surface area and field of view will depend upon the type of vehicle on which the spotter mirror 22 is used.

As an example, a panel delivery vehicle can be considered to be a truck. In this case, the specification given by FMVSS 571.111 S6 applies. FMVSS 571.111 S6b provides for a minimum 126 cm² (19.53 in²) surface area. The effective area of left outside mirror 10 having this size but also provided with the spotter mirror 22 can be arranged to be 196.8 cm² (30.5 in²).

As another example, the spotter mirror 22 can also be used on a passenger vehicle such as a sedan. In this case, FMVSS 571.111 S5.2.1 specifies the field of view for passenger cars. The spotter does not impact the field of view as described in this standard.

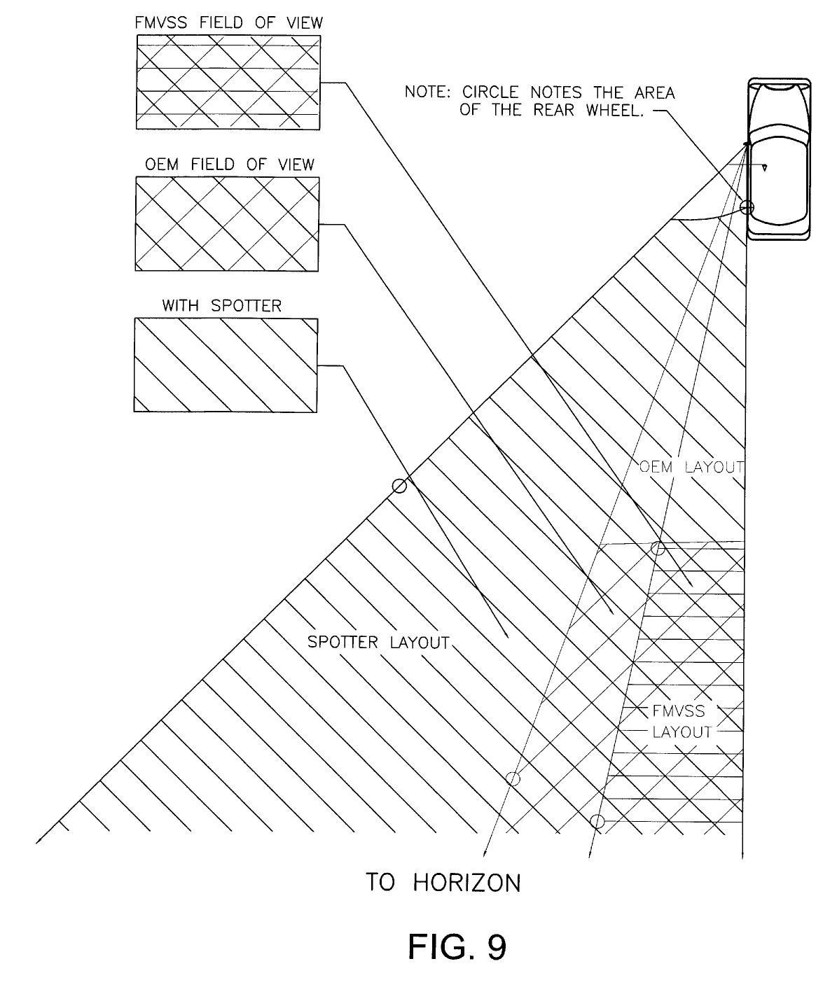

FIG. 9 demonstrates the field of view for a passenger vehicle as specified by FMVSS 571.111 S5.2.1, as provided by a typical left side outside OEM mirror such as the left outside mirror 10, and as provided by the left outside mirror 10 equipped with the spotter mirror 22. As can be seen, the spotter mirror 22 greatly expands the field of view.

Also, by placing the spotter mirror 22 in the upper left hand corner of the left outside mirror 10, the spotter mirror 22 is aimed to maximize its field of view to the areas not covered by the left outside mirror 10 without the spotter mirror 22. Those areas include, the area just ahead of the rear wheel at the side of the vehicle, and out to the side and back where the left outside mirror 10 does not view. With known auxiliary convex mirrors, the radius of curvature includes as much vertical (viewing the sky) as it does the road and back to the horizon. The spotter mirror 22 uses a combination of the amount of radius of curvature and the segment of a convex surface to aim the mirror to the areas a driver needs to see.

Further, the spotter mirror 22 incorporates the extended edges 50 and 52 at its top and outside edges to “wrap” the reflector 14 to aid in installation and insure proper placement the first time. Because of the aggressive nature of the adhesive used to install the spotter mirror 22 to the reflector 14, the installer gets only one chance to place the spotter mirror 22 on the left outside mirror 10. Thus, the extended edges 50 and 52 conform to the shape of the upper outside edge of the reflector 14 and/or the upper inside edge of the mirror housing 12 to accurately locate the spotter mirror 22 on the reflector 14.

Certain modifications of the present invention have been discussed above. Other modifications of the present invention will occur to those practicing in the art of the present invention. For example, the locators in the form of the extended edges 50 and 52 of the spotter mirror 22 are shown as one continuous edge that extends around the top 24 and the left side 30 of the spotter mirror 22.

However, these locators do not have to be continuous. They may instead be discontinuous locators such as periodically disposed projections that extend backwardly from the back 34 of the spotter mirror 22.

Also, the locators do not have to be edges. For example, the locators can be bumps on the back 34 of the spotter mirror 22 and corresponding dimples in the surface of the reflector 14, or vice versa.

Moreover, as described above, the adhesive of the back 34 is pre-applied to form a stick-on back side comprising an adhesive covered with a paper backing that can be removed at the time of installation. Instead, the adhesive that is used to bond the spotter mirror 22 to the reflector 14 can be applied to the back 34 and/or to the reflector 14 at the time of installation.

Furthermore, installation can be conducted in any desired order. For example, the spotter mirror 22 can be applied to the reflector 14 and then the reflector 14 can be applied to mirror housing 12. Alternatively, the reflector 14 can be applied to mirror housing 12 and then the spotter mirror 22 can be applied to reflector 14.

Additionally, while the spotter mirror 22 as described above is applied to the reflector 14 to form the left outside mirror 10, the spotter mirror 22 can be applied to the reflector 14 to form mirrors other than the left outside mirror 10.

Also, although the spotter mirror 22 uses the features described above, these features can be included in other forms of auxiliary convex mirrors for any similar application.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A compound vehicle mirror comprising:
a mirror housing:
a reflector mounted to the mirror housing; and,
a spotter mirror mounted to the reflector, wherein the spotter mirror includes a locator, and wherein the locator facilitates locating the spotter mirror at a predetermined location on the reflector.

2. The compound vehicle mirror of claim 1 wherein the reflector comprises a planar reflector, and wherein the spotter mirror includes a convex reflecting surface.

3. The compound vehicle mirror of claim 1 wherein the locator comprises a projection extending rearwardly beyond a back of the spotter mirror such that the projection wraps a perimeter edge of the reflector when the spotter mirror is mounted to the reflector, and wherein the projection is accommodated in a space between the perimeter edge of the reflector and the mirror housing.

4. The compound vehicle mirror of claim 3 wherein the projection comprising a continuous edge that extends rearwardly beyond a back of the spotter mirror such that the continuous edge wraps a perimeter edge of the reflector when the spotter mirror is mounted to the reflector, and wherein the continuous edge is accommodated in the space between the perimeter edge of the reflector and the mirror housing.

5. The compound vehicle mirror of claim 4 wherein the continuous edge extends rearwardly from a top and a left side of the spotter mirror.

6. The compound vehicle mirror of claim 1 further comprising an adhesive between a back of the spotter mirror and the reflector, wherein the adhesive bonds the spotter mirror to the reflector.

7. The compound vehicle mirror of claim 6 wherein the locator comprises a projection extending rearwardly beyond a back of the spotter mirror such that the projection wraps a perimeter edge of the reflector when the spotter mirror is mounted to the reflector, and wherein the projection is accommodated in a space between the perimeter edge of the reflector and the mirror housing.

8. The compound vehicle mirror of claim 7 wherein the projection comprising a continuous edge that extends rearwardly beyond a back of the spotter mirror such that the continuous edge wraps a perimeter edge of the reflector when the spotter mirror is mounted to the reflector, and wherein the continuous edge is accommodated in the space between the perimeter edge of the reflector and the mirror housing.

9. The compound vehicle mirror of claim 8 wherein the continuous edge extends rearwardly from a top and a left side of the spotter mirror.

10. A spotter mirror mountable to a reflector, wherein the spotter mirror comprises:
a back;
a front reflecting surface; and,
a locator, wherein the locator facilitates mounting of the spotter mirror on the reflector at a predetermined location on the reflector such that the back of the spotter mirror abuts the reflector.

11. The spotter mirror of claim 10 wherein the front reflecting surface comprises a convex front reflecting surface, and wherein the back of the spotter mirror is essentially planar.

12. The spotter mirror of claim 10 wherein the locator comprises a projection extending rearwardly beyond the back of the spotter mirror such that the projection is arranged to wrap a perimeter edge of the reflector when the spotter mirror is mounted to the reflector, and such that the projection is accommodated in a space between the perimeter edge of the reflector and the mirror housing when the spotter mirror is mounted to the reflector.

13. The spotter mirror of claim 12 wherein the projection comprising a continuous edge that extends rearwardly beyond the back of the spotter mirror such that the continuous edge wraps a perimeter edge of the reflector when the spotter mirror is mounted to the reflector, and wherein the continuous edge is accommodated in the space between the perimeter edge of the reflector and the mirror housing when the spotter mirror is mounted to the reflector.

14. The spotter mirror of claim 13 wherein the continuous edge extends rearwardly from a top and a left side of the spotter mirror.

15. The spotter mirror of claim 10 further comprising an adhesive on the back of the spotter mirror.

16. The spotter mirror of claim 15 wherein the locator comprises a projection extending rearwardly beyond the back of the spotter mirror such that the projection is arranged to wrap a perimeter edge of the reflector when the spotter mirror is mounted to the reflector, and such that the projection is accommodated in a space between the perimeter edge of the reflector and the mirror housing when the spotter mirror is mounted to the reflector.

17. The spotter mirror of claim 16 wherein the projection comprising a continuous edge that extends rearwardly beyond the back of the spotter mirror such that the continuous edge wraps a perimeter edge of the reflector when the spotter mirror is mounted to the reflector, and wherein the continuous edge is accommodated in the space between the perimeter edge of the reflector and the mirror housing when the spotter mirror is mounted to the reflector.

18. The spotter mirror of claim 17 wherein the continuous edge extends rearwardly from a top and a left side of the spotter mirror.

19. A method comprising:
locating a spotter mirror on a reflector so that a locator edge along two adjacent sides of the spotter mirror enters a space between the reflector and a vehicle mirror housing and so that a back of the spotter mirror lies essentially flat against the reflector; and,
adhesively bonding the back of the spotter mirror to the reflector.

20. The method of claim 19 wherein the locating of a spotter mirror on a reflector so that a locator edge along two adjacent sides of the spotter mirror enters a space between the reflector and a vehicle mirror housing comprises locating the spotter mirror on the reflector so that a locator edge along a top and a left side of the spotter mirror enters the space between the reflector and the vehicle mirror housing.
